(19) United States
(12) Patent Application Publication
(10) Pub. No.: US 2013/0255801 A1
(43) Pub. Date: Oct. 3, 2013

(54) FLUID SUPPLY DEVICE

(71) Applicant: MURATA MANUFACTURING CO., LTD., NAGAOKAKYO-SHI (JP)

(72) Inventors: Atsuhiko HIRATA, Nagaokakyo-shi (JP); Gaku KAMITANI, Nagaokakyo-shi (JP); Hiroyuki YOKOI, Nagaokakyo-shi (JP)

(21) Appl. No.: 13/906,377

(22) Filed: May 31, 2013

Related U.S. Application Data
(63) Continuation of application No. PCT/JP2011/079523, filed on Dec. 20, 2011.

(30) Foreign Application Priority Data
Dec. 24, 2010 (JP) 2010-287260

(51) Int. Cl. G05D 7/01

(52) U.S. Cl. CPC G05D 7/012
USPC 137/505.14; 137/505

(57) ABSTRACT

A fluid supply device includes a fluid supply source, a valve, a differential-pressure generator, and a pressurizing device. The valve includes a casing, a displacement member that divides an inside of the casing into a first valve chamber and a second valve chamber, the displacement member being displaced by a pressure of a fluid being exerted on a front main surface and a back main surface of the displacement member, a first opening provided in the first valve chamber, a second opening provided in the first valve chamber, and a third opening provided in the second valve chamber. Thus, flow rate fluctuations are reduced even when the pressure on the ejection side or the suction side of the device fluctuates due to changes in atmospheric conditions.

### BACKGROUND OF THE INVENTION

1. Field of the Invention

The present invention relates to fluid supply devices, and particularly, to a fluid supply device that stably supplies fluids.

2. Description of the Related Art

Various types of pumps, such as a micropump, for driving fluids are used in fluid supply devices to supply fuel to fuel cell systems, to supply solutions, or to vaporize aromatics.

As an example of the above-described micropump, International Publication No. 2008-007634 discloses a piezoelectric pump including check valves disposed in an inlet port and an outlet port to prevent a fluid from flowing backward. Depending on a driving state of a fuel cell system, the pressure of a fluid flowing from a fuel cartridge to a piezoelectric pump rises in some cases. Since the piezoelectric pump includes the check valves, the piezoelectric pump can prevent a fluid from flowing backward, but cannot prevent the fluid from flowing forward. Thus, the pump has a problem in that the pump excessively supplies fuel when a high pressure is applied to an inlet side of the piezoelectric pump.

In view of this problem, providing a valve between a fuel cartridge and a pump or subsequent to a pump has been considered. Known examples of valves used for this purpose include an electromagnetic valve and a piezoelectric valve each of which is opened and closed by an active element, such as an electromagnetic coil or a piezoelectric element. For example, International Publication No. 2008-081767 describes a valve driven by a piezoelectric element. However, an active element is more likely to break down. For example, in the case of a piezoelectric valve, the piezoelectric element requires delicate handling because the piezoelectric element is more likely to crack or migration is more likely to occur in the piezoelectric element.

Generally, a pump has P-Q (pressure to flow rate) characteristics illustrated in FIG. 23. Specifically, when the pressure ΔP (a difference between an ejection-side pressure and a suction-side pressure) changes, the flow rate Q changes. Since the flow rate changes if the ejection-side pressure or the suction-side pressure changes due to changes in surrounding environment, it is difficult for a pump to continuously eject a fluid at a constant flow rate. To solve this problem, use of a pump having a large maximum pressure relative to a maximum flow rate has been considered. However, this pump has a relatively small flow rate, and thus, cannot supply a fluid at a required rate.

### SUMMARY OF THE INVENTION

Preferred embodiments of the present invention provide a fluid supply device that can stably supply a fluid regardless of atmospheric changes and that opens and closes a valve without using an active element to cause the fluid to smoothly flow forward therethrough.

A fluid supply device according to a preferred embodiment of the present invention includes a fluid supply source, a valve, a differential-pressure generator, and a pressurizing device. The valve includes a valve casing, a displacement member that divides the valve casing into a first valve chamber and a second valve chamber, the displacement member being displaced by a pressure of a fluid being exerted on a front main surface and a back main surface of the displacement member, a first opening provided on a side of the valve casing on which the first valve chamber is provided, the first opening being connected to a fluid inflow side, and the first opening being connected to an ejection side of the differential-pressure generator that generates a pressure difference between the first valve chamber and the second valve chamber, a second opening provided on the side of the valve casing on which the first valve chamber is provided, the second opening being connected to a fluid outflow side, and a third opening provided on a side of the valve casing on which the second valve chamber is provided, the third opening being an opening through which a fluid flows inward, the fluid being separated from the fluid flowing inward through the first opening and supplied from the fluid supply source that also supplies the fluid flowing inward through the first opening. The displacement member is urged by the pressurizing device towards the first valve chamber and prevents the first opening and the second opening from being connected to each other. The displacement member is displaced so as to connect the first opening and the second opening to each other when a force of the fluid flowing through the first opening exerted on the main surface of the displacement member facing the first valve chamber is greater than a force of the fluid flowing through the third opening exerted on the main surface of the displacement member facing the second valve chamber.

In the fluid supply device, the displacement member is urged by the pressurizing device towards the first valve chamber. Thus, the flow rate fluctuations are reduced even when the ejection-side pressure or the suction-side pressure of the fluid supply device fluctuates due to changes in atmospheric conditions as long as the pressure is equal or substantially equal to or below the applied pressure. Consequently, the fluid can be stably supplied. In addition, the valve includes a displacement member that is displaced when the pressure of the fluid flowing into one valve chamber is made different from the pressure of the fluid flowing into the other valve chamber and thus different forces are exerted on the front and back surfaces of the displacement member. Thus, the valve can be opened and closed without using a particular active element, such as an electromagnetic element or piezoelectric element, for example.

Furthermore, when the fluid supply device is not in operation, the second opening is closed by the displacement member. The first opening and the second opening become connected when the differential-pressure generator makes the force of the fluid exerted on the front surface of the displacement member different from the force of the fluid exerted on the back surface of the displacement member (i.e., makes the force exerted on the first valve chamber side different from the force exerted on the second valve chamber side). Thus, while the fluid supply device is not in operation, the fluid does not leak from the second opening even if the fluid pressure on the first opening increases so as to prevent excessive supply of the fluid. Moreover, the fluid supply device does not require an electromagnetic coil or a piezoelectric element as a driving power source since the fluid supply device uses the pressure of the fluid as a driving power source. Thus, the fluid supply device does not experience failures that typically occur in such a driving power source, and is thus highly reliable.

According to various preferred embodiments of the present invention, a fluid can be stably supplied regardless of atmospheric changes and a valve can be opened and closed without using an active element so that the fluid smoothly flows forward.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 schematically illustrates a fluid supply device according to a first preferred embodiment of the present invention.

FIG. 2 is an exploded perspective view of a passive valve of the fluid supply device.

FIG. 3 is a cross-sectional view of differential-pressure generator (micropump) of the fluid supply device.

FIG. 4 illustrates an operation of the passive valve illustrated in FIG. 2.

FIG. 5 schematically illustrates a fluid supply device according to a second preferred embodiment of the present invention.

FIG. 6 is a cross-sectional view of a passive valve according to an example of a preferred embodiment of the present invention.

FIG. 7 is a plan view of a reinforcing plate of the passive valve.

FIG. 8 illustrates a passive valve including another reinforcing plate.

FIG. 9 schematically illustrates an aromatic vaporizer according to a first example of a preferred embodiment of the present invention.

FIG. 10 schematically illustrates an aromatic vaporizer according to a second example of a preferred embodiment of the present invention.

FIG. 11 schematically illustrates an aromatic vaporizer according to a third example of a preferred embodiment of the present invention.

FIG. 12 schematically illustrates a fluid supply device according to a third preferred embodiment of the present invention.

FIG. 13 schematically illustrates a fluid supply device according to a fourth preferred embodiment of the present invention.

FIG. 14 schematically illustrates a fluid supply device according to a fifth preferred embodiment of the present invention.

FIG. 15 schematically illustrates a fluid supply device according to a sixth preferred embodiment of the present invention.

FIG. 16 schematically illustrates a fluid supply device according to a seventh preferred embodiment of the present invention.

FIG. 17 schematically illustrates a fluid supply device according to an eighth preferred embodiment of the present invention.

FIG. 18 schematically illustrates a fluid supply device according to a ninth preferred embodiment of the present invention.

FIG. 19 is a graph showing a flow-rate fluctuation rate relative to the pressure on an input-side of a pump according to the seventh preferred embodiment of the present invention.

FIG. 20 is a graph showing a flow-rate fluctuation rate relative to the pressure on an output-side of a pump according to the seventh preferred embodiment of the present invention.

FIG. 21 is a graph showing a flow-rate fluctuation rate relative to the pressure on an input-side of a pump in response to applications of various pressures in the fluid supply device according to the seventh preferred embodiment of the present invention.

FIG. 22 is a graph showing a flow-rate fluctuation rate relative to the pressure on an output-side of a pump in response to applications of various pressures in the fluid supply device according to the seventh preferred embodiment of the present invention.

FIG. 23 is a graph showing pressure-to-flow-rate characteristics of a pump.

### DETAILED DESCRIPTION OF THE PREFERRED EMBODIMENTS

Fluid supply devices according to various preferred embodiments of the present invention will be described with reference to accompanying drawings. Components that are the same or substantially the same throughout the drawings will be denoted by the same reference symbols and redundant descriptions are not provided.

### First Preferred Embodiment

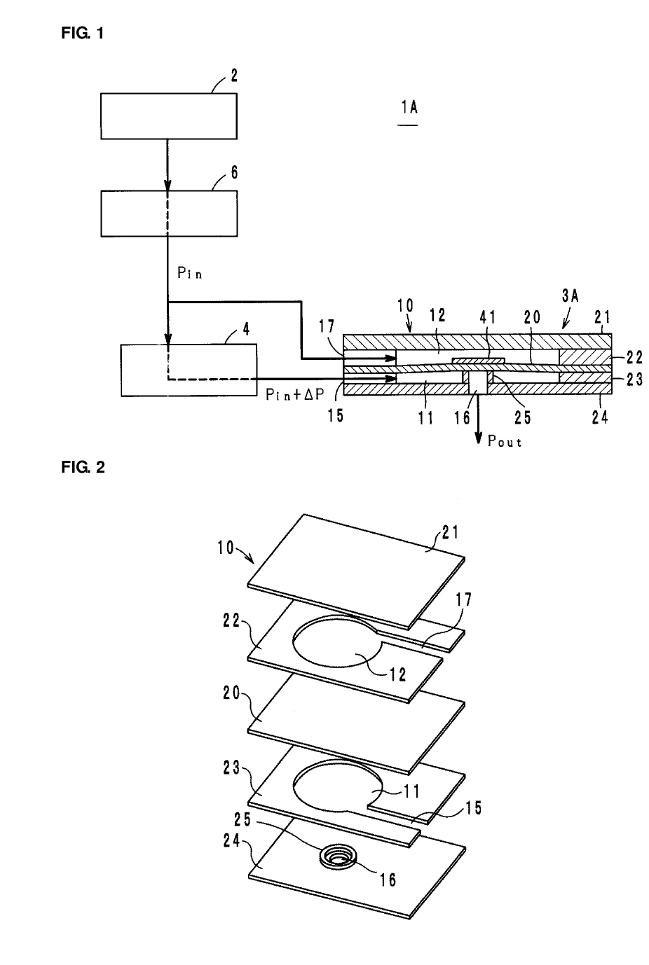

As illustrated in FIG. 1, a fluid supply device 1A according to a first preferred embodiment of the present invention primarily includes a fluid source 2, a passive valve 3A, a pump 4 defining differential-pressure generator, and a pressurizing pump 6. The pressurizing pump 6 is preferably disposed upstream from the pump 4 and supplies a fluid to the pump 4 and the passive valve 3A.

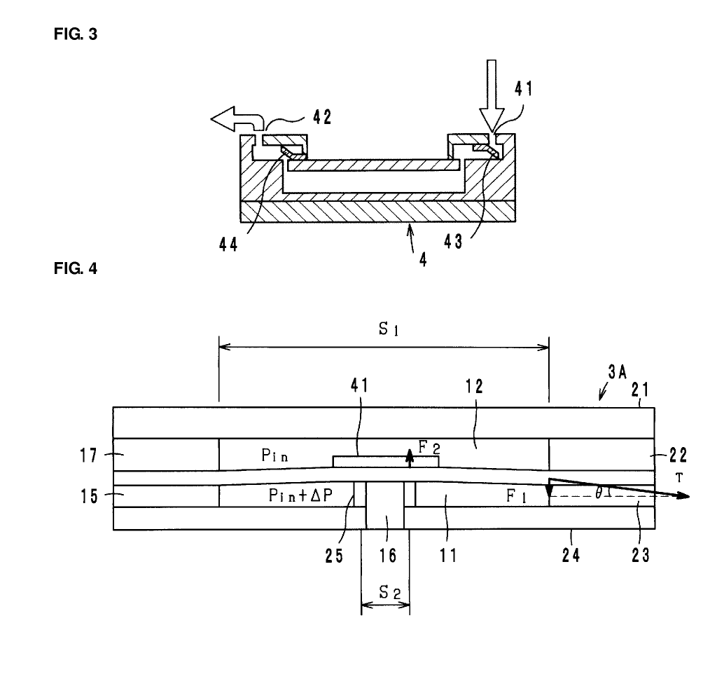

The passive valve 3A includes a valve casing 10, a diaphragm 20 that divides the inside of the valve casing 10 into a first valve chamber 11 and a second valve chamber 12, a comparative inlet-side opening (third opening) 17 provided in the second valve chamber 12, an inlet-side opening (first opening) 15 provided in the first valve chamber 11, and an outlet-side opening (second opening) 16. The comparative inlet-side opening 17 is connected to an ejection side of the pressurizing pump 6. The inlet-side opening 15 is connected to an ejection port 42 of the pump 4 (see FIG. 3). The pump 4 used here is preferably a widely known micropump including check valves 43 and 44 in a suction port 51 and the ejection port 52, respectively.

As illustrated in FIG. 2, the valve casing 10 includes a bottom board 24 including the opening 16, a board 23 including the first valve chamber 11 and the opening 15, the diaphragm 20, a board 22 including the second valve chamber 12 and the opening 17, and a top board 21 that are stacked on top of one another. A mount portion 25 protrudes from the bottom board 24 so as to face the first valve chamber 11. The mount portion 25 supports a center portion of the diaphragm 20 and shuts the opening 16. The center portion of the diaphragm 20, that is, a portion of the diaphragm 20 that contacts the mount portion 25 defining the opening 16 is preferably reinforced with a reinforcing plate 41.

Now, an operation of the passive valve 3A is described in detail with reference to FIG. 4. The area of each of the valve chambers 11 and 12 is denoted by S₁ and the area of the ejection-side opening 16 is denoted by S₂. The diaphragm 20 is preferably made of an elastic material, such as rubber, for example, and the other components are preferably made of resin or metal, for example. The height of the mount portion 25 is preferably greater than the thickness of the board (spacer) 23 and, thus, the diaphragm 20 is stretched under a tension T. Here, the diaphragm 20 is inclined at an angle θ. A component of force pulling the diaphragm 20 downward at a fixed portion is denoted by F₁ (=T sin θ). At this time, the mount portion 25 pushes the diaphragm 20 upward with a force F₂.

With the operations of the pumps 4 and 6, the pressure on the valve chamber 11 becomes greater than a pressure Pin on the valve chamber 12 by a pressure ΔP. The equilibrium of upward and downward forces exerted on the diaphragm 20 is expressed by the following equation, where Pout denotes the pressure on the opening 16:

PinS₁+F₁=(Pin+ΔP)(S₁−S₂)+PoutS₂+F₂.

Since it is only when the force F₂ is zero that the passive valve 3A is opened to cause a fluid flow out of the opening 16, the pressure ΔPop generated by the pumps 4 and 6 is assumed as the pressure ΔP and, thus, is expressed by the following equation:

ΔPop=(Pin−Pout)S₂/(S₁−S₂)+F₁/(S₁−S₂).

The difference between the pressures Pin and Pout is multiplied by S₂/(S₁−S₂) and, therefore, affects ΔPop. Thus, the operation pressure of the pumps 4 and 6 fluctuates to a lesser extent and the flow rate fluctuations are effectively reduced.

The force F₁ changes in accordance with ΔPop but is not dependent on the pressures Pin and Pout. This is because the reinforcing plate 41 is bonded to the center portion of the diaphragm 20. If the reinforcing plate 41 is not provided, the diaphragm 20 would be deformed by being attracted toward the opening 16 and the force F₁ would change according to the pressures Pin and Pout. Consequently, the operation pressure of the pumps 4 and 6 fluctuates to a large extent when the pressures Pin and Pout change. Depending on design requirements, the change in force F₁ can be reduced to a tolerable level without using the reinforcing plate 41.

The pressurizing pump 6 preferably defines the pressurizing device used to reliably maintain the relationship between the pressures Pin and Pout to be Pin>Pout, and is not necessarily be a pump. Particularly, the relationship only has to be Pin+ΔPop>Pout, where ΔPop denotes the pressure generated by the pumps 4 and 6 when the passive valve 3A is opened and the fluid is caused to flow to the opening 16.

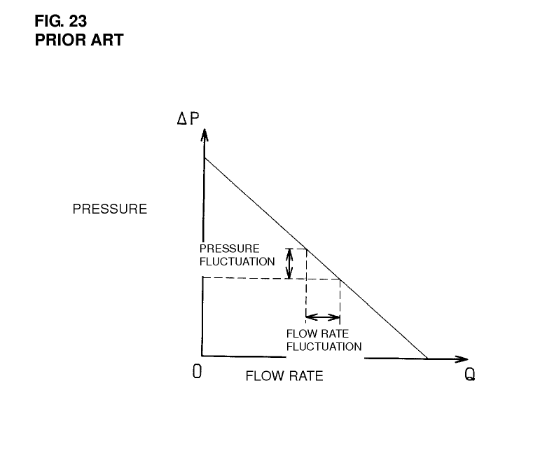

The ejection pump 4 has the P-Q (pressure-to-flow-rate) characteristics as shown in FIG. 23. In the first preferred embodiment, the pressurizing pump 6 is preferably disposed upstream from the ejecting pump 4. Thus, even when the ejection-side pressure or the suction-side pressure of the ejection pump 4 fluctuates due to changes in atmospheric conditions, the flow rate fluctuations are effectively reduced and a fluid can be continuously ejected at a constant flow rate.

In the passive valve 3A, the opening 16 is kept in a shut state even when the pressure from the fluid source is increased, and thus, the passive valve 3A does not excessively supply the fluid. In other words, a highly reliable valve is obtained without using an active element. Since the passive valve 3A does not require a driving circuit and electric power, which are required by a valve that includes an active element, a system into which the passive valve 3A is installed uses less energy and is reduced in size.

### Second Preferred Embodiment

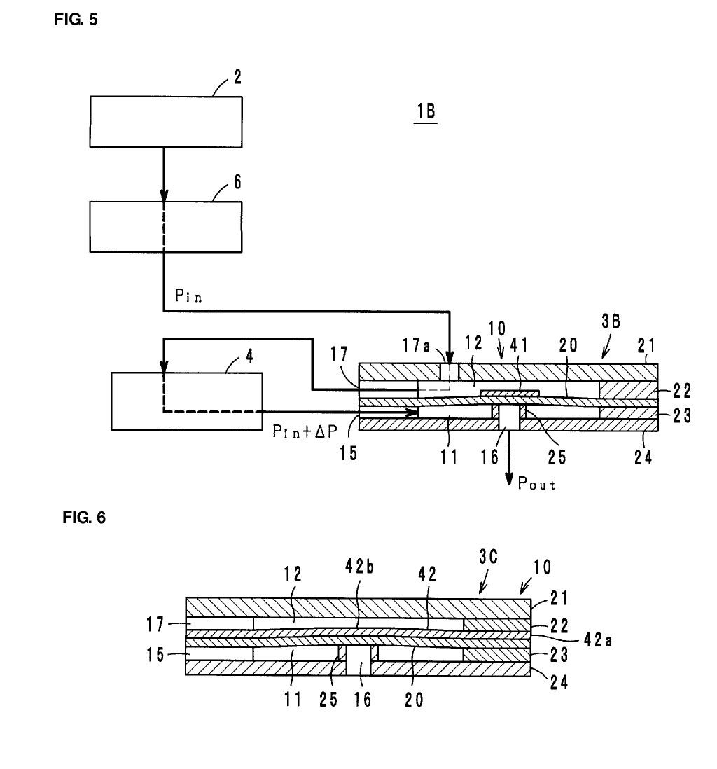

As illustrated in FIG. 5, a fluid supply device 1B according to a second preferred embodiment of the present invention includes a passive valve 3B. In the passive valve 3B, an opening 17a is provided in the top board 21 so as to be connected to the valve chamber 12. Other portions of the configuration are preferably similar to those in the passive valve 3A. In the second preferred embodiment, the pressurizing pump 6 is disposed upstream from the ejection pump 4, the ejection side of the pressurizing pump 6 is connected to the opening 17a, the opening 17 is connected to the suction side of the ejection pump 4, and the ejection side of the ejection pump 4 is connected to the opening 15.

Other portions of the configuration of the fluid supply device 1B according to the second preferred embodiment are preferably similar to those according to the first preferred embodiment. The passive valve 3B operates substantially similarly to the passive valve 3A. Thus, in the second preferred embodiment, even when the ejection-side pressure or the suction-side pressure of the ejection pump 4 fluctuates due to changes in atmospheric conditions, the flow rate fluctuations can be reduced and a fluid can be continuously ejected at a constant flow rate.

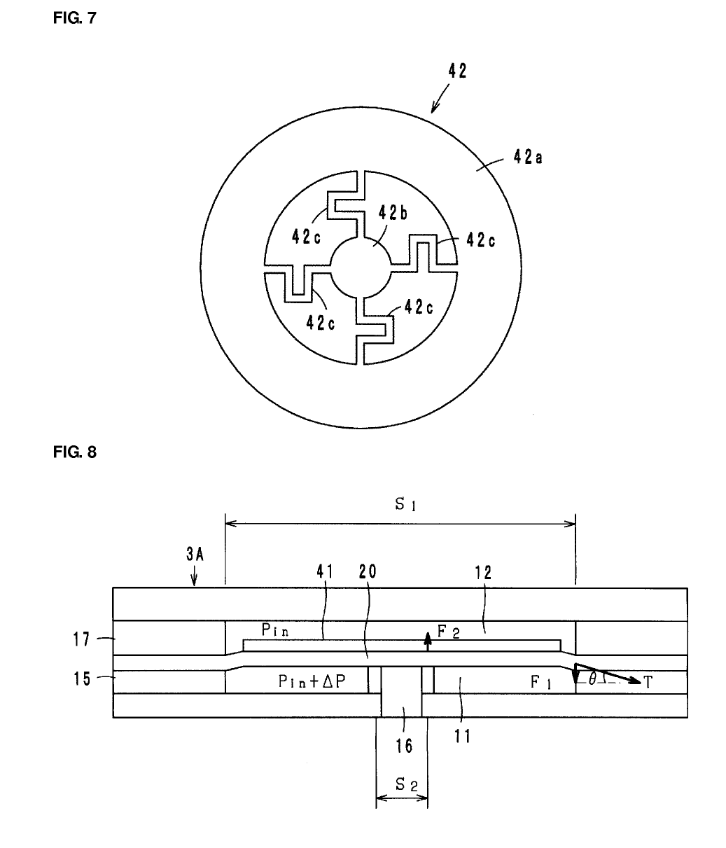

FIG. 6 illustrates a passive valve 3C that includes a reinforcing plate 42 illustrated in FIG. 7, instead of the reinforcing plate 41. The configuration of the main portion of the passive valve 3C is preferably the same or substantially the same as that of the passive valve 3A.

The reinforcing plate 42 is obtained by connecting an annular circumferential portion 42a having the same or substantially the same outer diameter as the diaphragm 20 to a pressing portion 42b in a center portion via bent spring portions 42c. The reinforcing plate 42 is stacked on the upper side of the diaphragm 20. The circumferential portion 42a is pressure-bonded to and held by the boards 22 and 23. A portion of the diaphragm 20 corresponding to the pressing portion 42b is in pressure contact with the mount portion 25. By using the reinforcing plate 42, the diaphragm 20 can be prevented from being attracted toward the opening 16 and, thus, the force F₁ is prevented from changing when the relationship Pin>Pout is satisfied.

As illustrated in FIG. 8, the size of the reinforcing plate 41 may preferably be increased so as to be close to the inner diameter of the valve chambers 11 and 12. Thus, the change of the force F₁ due to the pressure ΔP can be reduced.

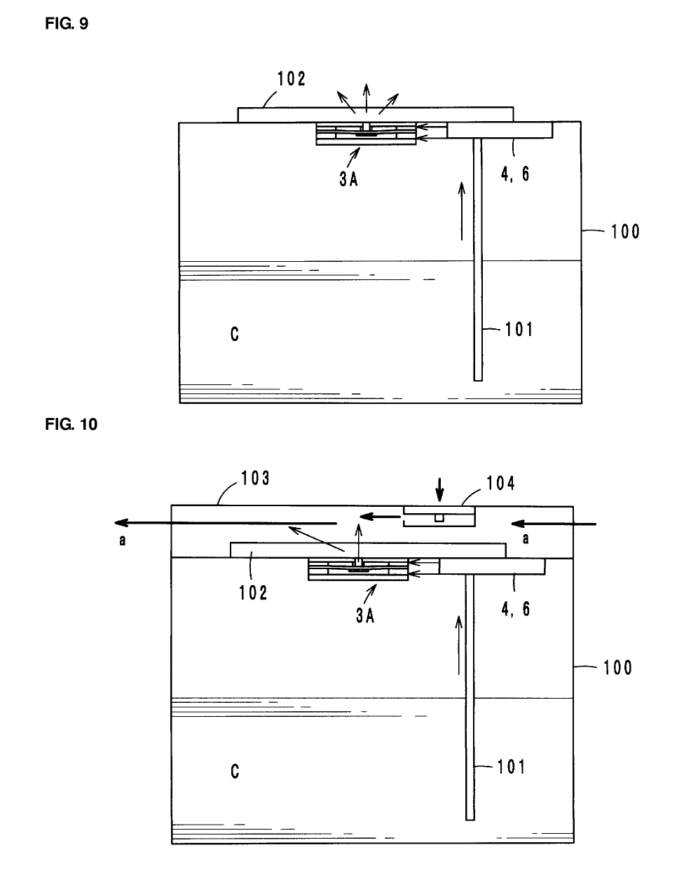

As illustrated in FIG. 9, in an aromatic vaporizer according to a first example of a preferred embodiment of the present invention, the ejection pump 4, the pressurizing pump 6, and the passive valve 3A are provided in a ceiling portion of a container 100 that includes an aromatic C. A suction pipe 101 is connected to the pump 4 or 6. A vaporizing member 102 is disposed on the surface of the container 100 on the ejection side of the passive valve 3A.

In order to reduce pressure fluctuations inside the container 100, minute air holes that introduce air into the container 100 in accordance with a reduction of the aromatic C may be provided in the container 100. Instead, the container 100 itself may contract in accordance with a reduction of the aromatic C so as to compensate for the pressure fluctuations inside the container 100. However, in either case, the liquid level of the aromatic C falls as a result of a reduction of the aromatic C, and the pressure required to suck the aromatic C changes accordingly. By combining the ejection pump 4 with the pressurizing pump 6, fluctuations in the load applied to the pump 4 decrease so as to enable continuous supply of the aromatic C to the vaporizing member 102 at a constant flow rate.

As illustrated in FIG. 10, an aromatic vaporizer according to a second example of a preferred embodiment of the present invention has substantially the same configuration as the first example illustrated in FIG. 9, but differs in that the vaporizing member 102 is covered by a cover 103 and a blower 104 is disposed directly above the vaporizing member 102 so as to cause air to flow in the direction of arrow a. The aromatic vaporizer according to the second example can more reliably vaporize the aromatic C.

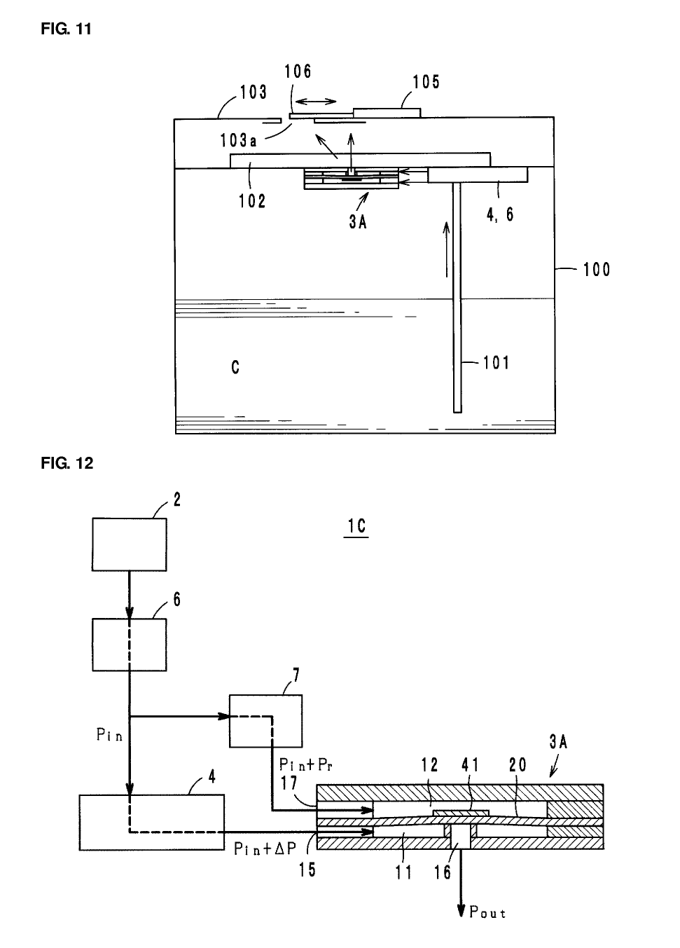

As illustrated in FIG. 11, an aromatic vaporizer according to a third example of a preferred embodiment of the present invention preferably has substantially the same configuration as the first example illustrated in FIG. 9, but differs in that the vaporizing member 102 is covered by a cover 103 and a shutter 106 driven by a driving member, such as a linear actuator 105, for example, is attached to a window portion 103a of the cover 103. The aromatic vaporizer according to the third example can regulate and stabilize the evaporation rate of the aromatic C.

As described above with reference to FIG. 4, the passive valve 3A operates only when the pressure on the valve chamber 11 becomes greater than the pressure Pin on the valve chamber 12 by the pressure ΔPop. By adjusting the pressure on the valve chamber 12 independently of the pressure on the valve chamber 11, the pressure ΔPop required in order for the passive valve 3A to operate can be changed. As a result of this change, the flow rate changes. This means that the flow rate can be adjusted by adjusting the applied pressure ΔPop. Hereinbelow, a fluid supply device including such a flow-rate adjusting device will be described.

### Third Preferred Embodiment

As illustrated in FIG. 12, a fluid supply device 1C according to a third preferred embodiment of the present invention includes the passive valve 3A and a second pressurizing pump 7 that defines a flow-rate adjusting device. The second pressurizing pump 7 is disposed between the first pressurizing pump 6 and the opening 17 of the passive valve 3A. Since a pressure Pr generated by the second pressurizing pump 7 is added to the pressure Pin generated by the first pressurizing pump 6, the pressure applied to the second valve chamber 12, that is, the pressure applied to the opening 16 which defines an ejection port changes so as to adjust the flow rate at which a fluid flows through the opening 16.

The second pressurizing pump 7 need not increase the flow rate but only needs to apply a pressure. Thus, if the fluid is a liquid, an electroosmotic flow pump or other pump is suitable as the second pressurizing pump 7. Alternatively, a piezoelectric micropump may be used. Here, the first pressurizing pump 6 may be excluded.

### Fourth Preferred Embodiment

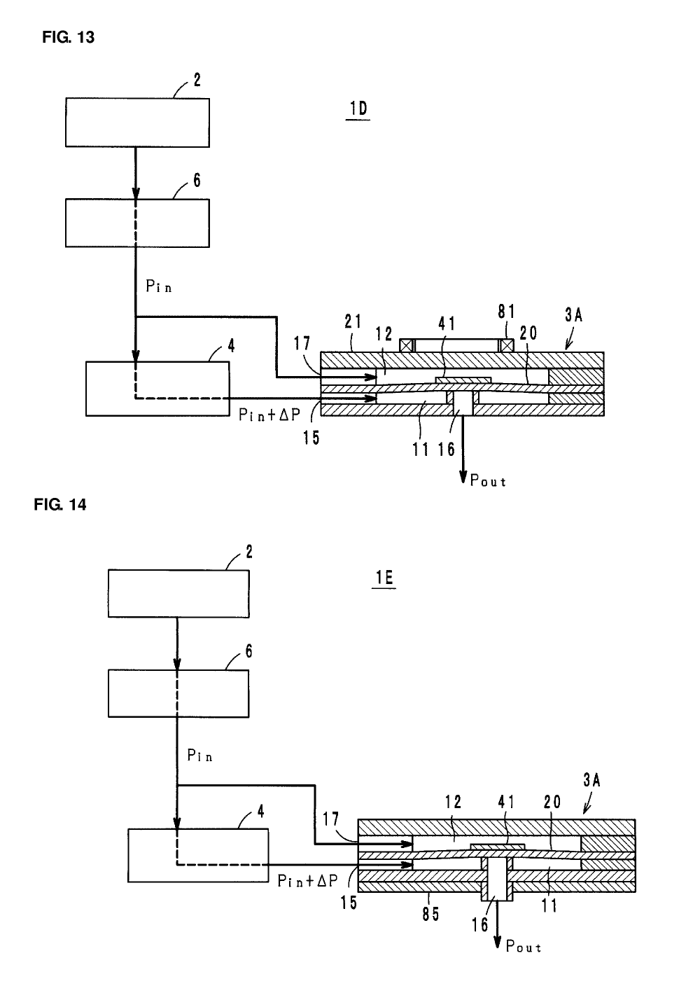

As illustrated in FIG. 13, a fluid supply device 1D according to a fourth preferred embodiment of the present invention includes the passive valve 3A and an electromagnetic coil 81 that defines a flow-rate adjusting device. The electromagnetic coil 81 is disposed on the top board 21 at a position corresponding to the opening 16. The reinforcing plate 41 includes a magnetic body. When an electric current is applied to the electromagnetic coil 81, the reinforcing plate 41 made of a magnetic material is attracted toward the electromagnetic coil so as to reduce the applied pressure ΔPop. Thus, the flow rate of the passive valve 3A is adjusted.

### Fifth Preferred Embodiment

As illustrated in FIG. 14, a fluid supply device 1E according to a fifth preferred embodiment of the present invention includes the passive valve 3A and a piezoelectric element 85 that defines a flow-rate adjusting device. A ring-shaped piezoelectric element 85 that operates as a unimorph is bonded and fixed to the back surface of the bottom board 24. When a voltage is applied to the piezoelectric element 85, the mount portion 25 is displaced upward or downward so as to change the applied pressure ΔPop. Thus, the flow rate of the passive valve 3A is adjusted.

### Sixth Preferred Embodiment

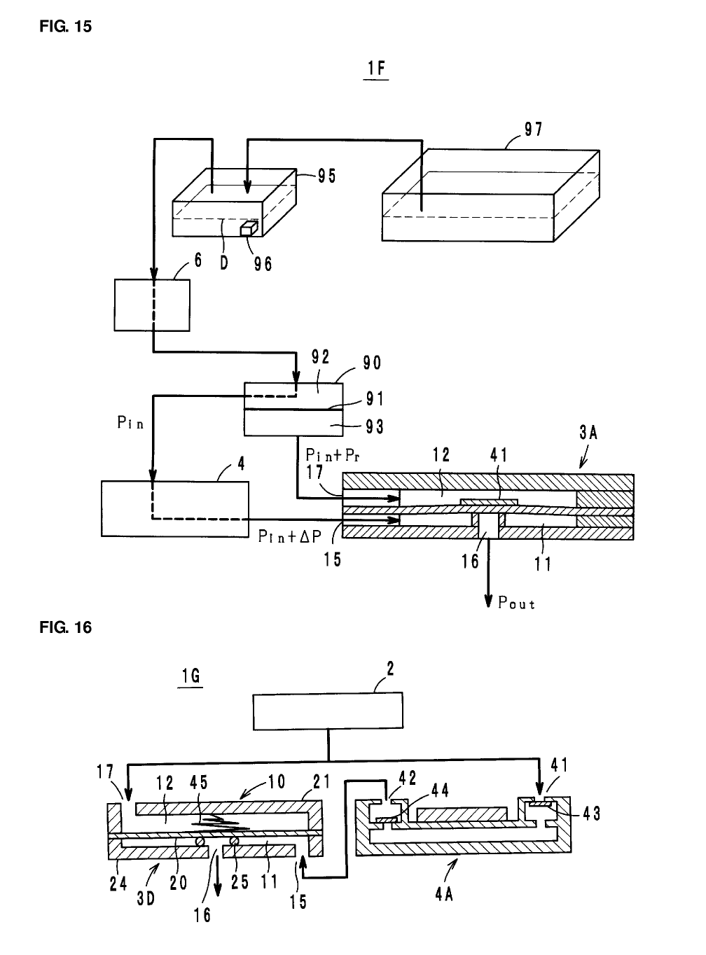

As illustrated in FIG. 15, a fluid supply device 1F according to a sixth preferred embodiment of the present invention includes the passive valve 3A and an osmotic pump 90 that defines a flow-rate adjusting device. The osmotic pump 90 includes an osmosis membrane 91 that separates chambers 92 and 93 from each other. The chamber 92 is connected to an ejection side of the pressurizing pump 6 and to a suction side of the ejection pump 4. The chamber 93 is connected to the opening 17 of the passive valve 3A.

In addition, a solute-concentration-regulated medical solution bath 95 is connected to a suction side of the pressurizing pump 6 and supplies a liquid or solution for medical use D in which the concentration of a solute is regulated to the pressurizing pump 6. The solute-concentration-regulated liquid or solution for medical use D is prepared by supplying pure water from a pure water bath 97 to the solute-concentration-regulated medical solution bath 95 and dissolving a concentration adjusting substance of a solute source 96 in the pure water.

With this configuration, when the concentration of the solute in the liquid or solution for medical use D increases, the liquid in the valve chamber 12 tries to flow out of the valve chamber 12 through the osmosis membrane 91 and, thus, the pressure on the valve chamber 12 decreases. Consequently, the pressure ΔPop required in order for the passive valve 3A to operate decreases and the flow rate increases. The configuration used to supply the solute-concentration-regulated liquid or solution for medical use D to the osmotic pump 90 may be appropriately determined. An electroosmotic flow pump may preferably be used instead of the osmotic pump 90.

### Seventh Preferred Embodiment

As illustrated in FIG. 16, a fluid supply device 1G according to a seventh preferred embodiment of the present invention includes a passive valve 3D and a pump 4A. The fluid supply device 1G includes a spring member (a coil spring 45 is illustrated as a preferable example) instead of the pressurizing pump 6 illustrated in the first preferred embodiment. The configuration of the passive valve 3D differs from that according to the first preferred embodiment in the positions of the first opening 15, the second opening 16, and the third opening 17. However, the passive valve 3D preferably operates similarly to that according to the first preferred embodiment. The coil spring 45 is disposed in the second valve chamber 12 and presses a diaphragm 20 against the mount portion 25 at a predetermined spring pressure.

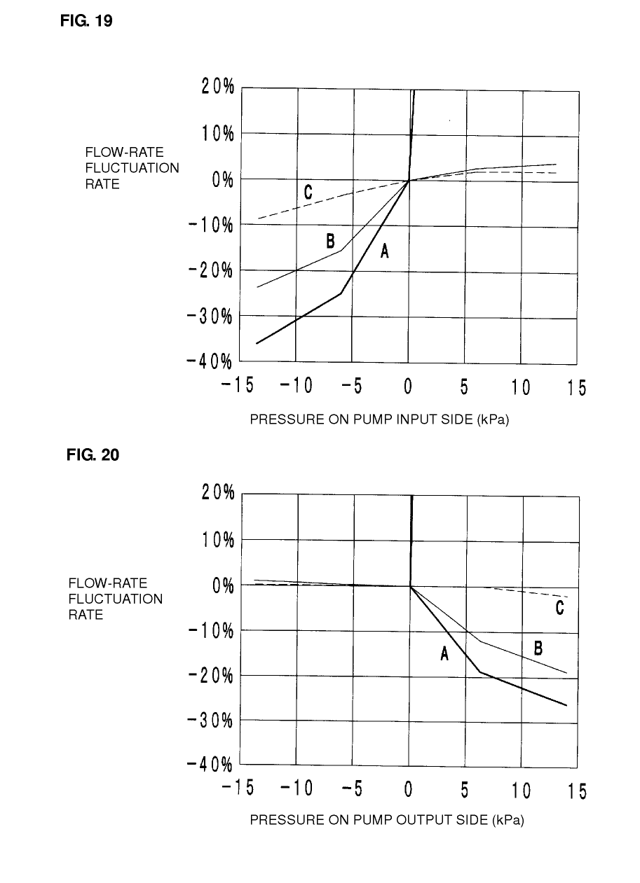

Thus, even when the ejection-side pressure or the suction-side pressure of the fluid supply device 1G changes due to changes in atmospheric conditions, in the seventh preferred embodiment, the fluid supply device 1G can reduce the flow rate fluctuations and continuously eject a fluid at a constant flow rate. This operation will be described below in detail with reference to FIGS. 19 to 22.

The pump 4A differs from the pump 4 illustrated in FIG. 3 only in the positions of the check valves 43 and 44 and operates similarly thereto.

A metal (cylindrical or conical shaped) coil spring or a flat spring, for example, may preferably be used as the spring member. To reduce the height of the valve 3D or to provide a uniform spring constant (for reduction of the difference in spring constant between individual springs), a conical coil spring is preferably provided.

### Eighth Preferred Embodiment

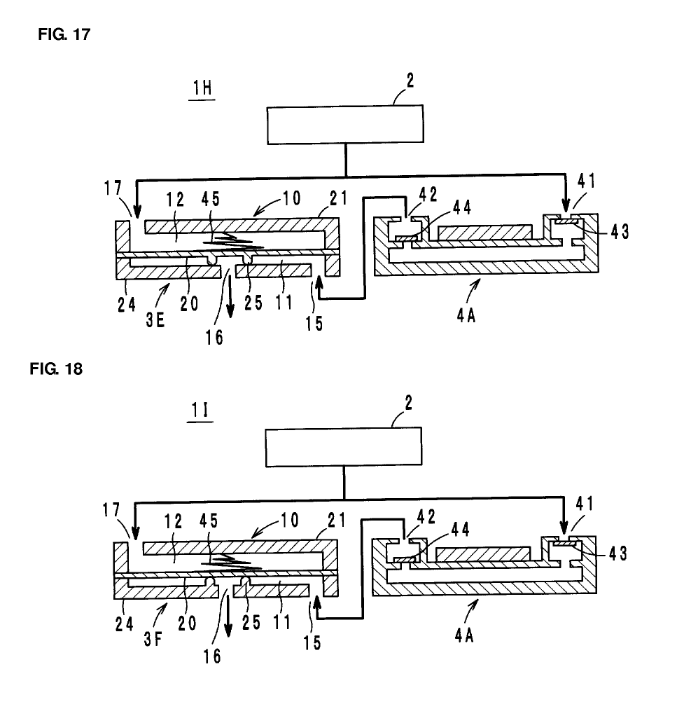

As illustrated in FIG. 17, a fluid supply device 1H according to an eighth preferred embodiment of the present invention includes a passive valve 3E in which the mount portion 25 is integrated with the diaphragm 20. Other portions of the configuration are preferably the same or substantially the same as those according to the seventh preferred embodiment. The operations are the same or substantially the same as those in the case of the seventh preferred embodiment.

### Ninth Preferred Embodiment

As illustrated in FIG. 18, a fluid supply device 1I according to a ninth preferred embodiment includes a passive valve 3F in which the mount portion 25 is integrated with the bottom board 24 of the valve casing 10. Other portions of the configuration are preferably the same or substantially the same as those according to the seventh preferred embodiment. The operations are the same or substantially the same as those in the case of the seventh preferred embodiment.

According to the seventh preferred embodiment (as well as the eighth and ninth preferred embodiments), by using the spring member (coil spring 45) as a pressurizing device, the valve 3D can be prevented from being opened. Thus, when the difference between the ejection-side pressure and the suction-side pressure of the fluid supply device 1G is below the pressure applied to the valve 3D, the fluid supply device 1G ejects a fluid at a constant rate.

FIG. 19 illustrates the flow-rate fluctuation rate of the valve 3D relative to the pressure on the input-side of the pump 4A while FIG. 20 illustrates the flow-rate fluctuation rate of the valve 3D relative to the pressure on the output-side of the pump 4A. The line A represents the rate in the case in which the pump illustrated in FIG. 16 is used alone, the line B represents the rate in the case in which the pressurizing device illustrated in FIG. 16 is not provided, and the line C represents the rate in the case in which the configuration illustrated in FIG. 16 is used and the pressure applied by the pressurizing device is about 12 kPa. These results show that, when the pressurizing device applies pressure, the flow rate fluctuations can be reduced.

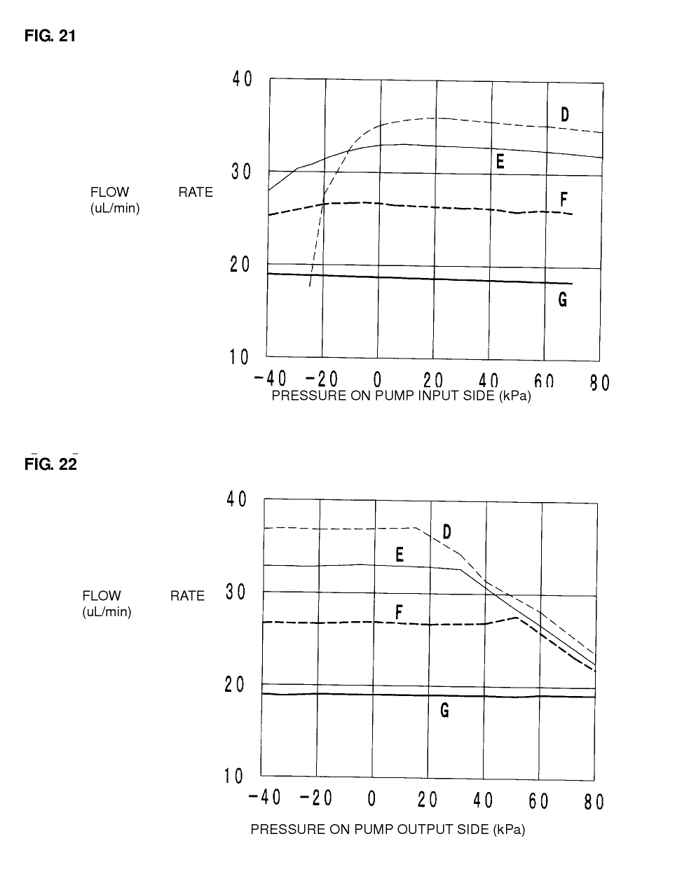

Subsequently, flow rate fluctuations of the configuration illustrated in FIG. 16 were measured by changing the pressure applied by the pressurizing device into various different levels. The results are represented by FIG. 21 and FIG. 22. FIG. 21 shows the flow rate of the valve 3D relative to the pressure on the input-side of the pump 4A, where the curved line D represents the rate in the case in which the applied pressure is about 10 kPa, the curved line E represents the rate in the case in which the applied pressure is about 20 kPa, the curved line F represents the rate in the case in which the applied pressure is about 40 kPa, and the curved line G represents the rate in the case in which the applied pressure is about 60 kPa. FIG. 22 shows the flow rate of the valve 3D relative to the pressure on the output-side of the pump 4A, where the curved line D represents the rate in the case in which the applied pressure is about 10 kPa, the curved line E represents the rate in the case in which the applied pressure is about 20 kPa, the curved line F represents the rate in the case in which the applied pressure is about 40 kPa, and the curved line G represents the rate in the case in which the applied pressure is about 60 kPa. These results show that, at least when the pressure on the output-side of the pump is equal to or below the pressure applied by the pressurizing device, the flow rate fluctuations can be reduced.

Consequently, a fluid supply device having the configuration illustrated in FIG. 16 can stably supply a fluid regardless of atmospheric changes and open and close a valve without using an active element so that the fluid smoothly flows forward therethrough.

A fluid supply device according to the present invention is not limited to the preferred embodiments described above and can be modified in various manners within the scope of the present invention.

For example, a component other than a diaphragm may be used as a displacement member and an O-ring may be used instead of the mount portion. A fluid is not limited to the above-described aromatic or liquid fuel supplied to a fuel cell and may be a gaseous body.

As described above, preferred embodiments of the present invention are advantageous in that it can be used for a fluid supply device and, particularly, in that a fluid can be stably supplied regardless of atmospheric changes and a valve can be opened and closed without using an active element so that the fluid smoothly flows forward.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A fluid supply device comprising:
a fluid supply source;
a valve;
a differential-pressure generator; and
a pressurizing device; wherein
the valve includes:
a valve casing;
a displacement member that divides the valve casing into a first valve chamber and a second valve chamber, the displacement member being displaced by a pressure of a fluid being exerted on a front main surface and a back main surface of the displacement member;
a first opening provided on a side of the valve casing on which the first valve chamber is provided, the first opening being connected to a fluid inflow side, and the first opening being connected to an ejection side of the differential-pressure generator that generates a pressure difference between the first valve chamber and the second valve chamber;
a second opening provided on the side of the valve casing on which the first valve chamber is provided, the second opening being connected to a fluid outflow side; and
a third opening provided on a side of the valve casing on which the second valve chamber is provided, the third opening being an opening through which a fluid flows inward, the fluid being separated from the fluid flowing inward through the first opening and supplied from the fluid supply source that also supplies the fluid flowing inward through the first opening;
the displacement member is urged by the pressurizing device toward the first valve chamber and prevents the first opening and the second opening from being connected to each other; and
the displacement member is displaced so as to connect the first opening and the second opening to each other when a force of the fluid flowing through the first opening exerted on the main surface of the displacement member facing the first valve chamber is greater than a force of the fluid flowing through the third opening exerted on the main surface of the displacement member facing the second valve chamber.

2. The fluid supply device according to claim 1, wherein the pressurizing device is disposed upstream from the differential-pressure generator and applies an equal or substantially equal pressure to the first valve chamber and the second valve chamber.

3. The fluid supply device according to claim 1, wherein the pressurizing device is disposed inside the second valve chamber.

4. The fluid supply device according to claim 1, wherein the pressurizing device includes a spring member.

5. The fluid supply device according to claim 1, further comprising a flow-rate adjusting device that applies a predetermined pressure to the second opening.

6. The fluid supply device according to claim 5, wherein the flow-rate adjusting device includes a pressurizing pump.

7. The fluid supply device according to claim 5, wherein the flow-rate adjusting device includes an electromagnetic coil and a magnetic body that is operated by the electromagnetic coil while being fixed to the displacement member.

8. The fluid supply device according to claim 5, wherein the flow-rate adjusting device includes a piezoelectric element that displaces a mount portion that supports the displacement member at a position around the second opening.

9. The fluid supply device according to claim 5, wherein the flow-rate adjusting device includes an osmotic pump.

10. The fluid supply device according to claim 1, wherein a portion of the displacement member contacting the second opening is reinforced.

11. The fluid supply device according to claim 1, wherein the differential-pressure generating device includes a micropump.

12. The fluid supply device according to claim 5, wherein the flow-rate adjusting device includes an electroosmotic flow pump.

13. The fluid supply device according to claim 1, wherein the valve includes a reinforcing plate disposed on the displacement member adjacent to the second opening.

14. The fluid supply device according to claim 13, wherein the reinforcing plate has an outer diameter greater than a diameter of the second opening and less than an outer diameter of the displacement member and is arranged so as to overlap the second opening.

15. The fluid supply device according to claim 13, wherein the reinforcing plate has an outer diameter that is the same or substantially the same as an outer diameter of the displacement member.

16. The fluid supply device according to claim 15, wherein the reinforcing plate is connected to the displacement member at an annular circumferential portion of the reinforcing plate.

17. The fluid supply device according to claim 13, wherein an outer diameter of the reinforcing plate is the same or substantially the same as an inner diameter of at least one of the first and second valve chambers.

18. The fluid supply device according to claim 13, wherein the reinforcing plate includes an annular circumferential portion having the same or substantially the same diameter as the displacement member, a pressing portion provided in a central portion of the reinforcing plate, and a plurality of bent spring portions connecting the annular circumferential portion to the pressing portion.

19. The fluid supply device according to claim 1, wherein the displacement member is made of an elastic material.

20. A valve for use in a fluid supply device including a fluid supply source, a differential-pressure generator, and a pressurizing device, the valve comprising:
a valve casing;
a displacement member that divides the valve casing into a first valve chamber and a second valve chamber, the displacement member being displaced by a pressure of a fluid being exerted on a front main surface and a back main surface of the displacement member;
a first opening provided on a side of the valve casing on which the first valve chamber is provided, the first opening being connected to a fluid inflow side, and the first opening being arranged to be connected to an ejection side of the differential-pressure generator that generates a pressure difference between the first valve chamber and the second valve chamber;
a second opening provided on the side of the valve casing on which the first valve chamber is provided, the second opening being connected to a fluid outflow side; and
a third opening provided on a side of the valve casing on which the second valve chamber is provided, the third opening being an opening through which a fluid flows inward, the fluid being separated from the fluid flowing inward through the first opening and supplied from the fluid supply source that also supplies the fluid flowing inward through the first opening;
the displacement member is arranged to be urged by the pressurizing device toward the first valve chamber and prevents the first opening and the second opening from being connected to each other; and
the displacement member is arranged to be displaced so as to connect the first opening and the second opening to each other when a force of the fluid flowing through the first opening exerted on the main surface of the displacement member facing the first valve chamber is greater than a force of the fluid flowing through the third opening exerted on the main surface of the displacement member facing the second valve chamber.
